(19) United States
(12) Patent Application Publication
(10) Pub. No.: US 2012/0263898 A1
(43) Pub. Date: Oct. 18, 2012

(54) PHOTO-REGENERABLE OXYGEN SCAVENGING PACKAGING

(75) Inventor: Thevasahayam Arockiadoss, Chennai (IN)

(73) Assignee: EMPIRE TECHNOLOGY DEVELOPMENT, LLC, Wilmington, DE (US)

(21) Appl. No.: 13/320,767

(22) PCT Filed: Jun. 13, 2011
(86) PCT No.: PCT/IB2011/052558

§ 371 Date: Nov. 16, 2011

(30) Foreign Application Priority Data
Apr. 18, 2011 (IN) 1339/CHE/2011

(51) Int. Cl. B32B 1/08; B32B 27/00; B32B 15/04

(52) U.S. Cl. 428/35.2; 428/472; 428/412; 428/34.1

(57) ABSTRACT

Photo-regenerable oxygen scavenging packaging is generally disclosed. Some example embodiments may comprise tantalum oxide and/or manganese oxide arranged to act as a photo-regenerable oxygen scavenger. The tantalum oxide, if present, may operate as an oxygen scavenger when the tantalum oxide exists as tantalum (IV) oxide. Subjecting the tantalum oxide to light may transform at least a portion of the tantalum oxide existing as tantalum (V) oxide to tantalum (IV) oxide. The manganese oxide, if present, may operate as an oxygen scavenger when the manganese oxide exists as manganese (II) oxide. Subjecting the manganese oxide to light may transform at least a portion of the manganese oxide existing as manganese (III) oxide to manganese (II) oxide. Some example containers may include a structure defining an interior volume and a photo-regenerable oxygen scavenger disposed in fluidic communication with the interior volume.

### CROSS REFERENCE TO RELATED APPLICATIONS

The present application claims priority to a corresponding patent application filed in India and having application number 1339/CHE/201.1 filed on Apr. 18, 2011, the entire contents of which are herein incorporated by reference.

### BACKGROUND

The present disclosure generally pertains to containers and, more particularly, to photo-regenerable oxygen scavenging packaging.

### SUMMARY

Oxygen scavenging packaging is generally disclosed. Some example embodiments may include methods, apparatus, and/or systems pertaining to oxygen scavenging packaging. For example, some described methods, apparatus, and/or systems may include photo-regenerable oxygen scavenging packaging.

Some example packaging materials according to the present disclosure may include a substrate and a photo-regenerable oxygen scavenger comprising one or more of tantalum oxide and manganese oxide operatively associated with the substrate. The tantalum oxide, when present, may operate as an oxygen scavenger when the tantalum oxide exists as tantalum (IV) oxide. Subjecting the tantalum oxide to light may transform at least a portion of the tantalum oxide existing as tantalum (V) oxide to tantalum (IV) oxide. The manganese oxide, when present, may operate as an oxygen scavenger when the manganese oxide exists as manganese (II) oxide. Subjecting the manganese oxide to light may transform at least a portion of the manganese oxide existing as manganese (III) oxide to manganese (II) oxide.

Some example containers according to the present disclosure may include a structure at least partially defining an interior volume for receiving contents therein and a photo-regenerable oxygen scavenger disposed in fluidic communication with the interior volume. The oxygen scavenger may include one or more of tantalum oxide and manganese oxide. The interior volume may be substantially fluidicly isolated from an ambient environment. The tantalum oxide, if present, may operate as an oxygen scavenger when the tantalum oxide exists as tantalum (IV) oxide. Subjecting the tantalum oxide to light may transform at least a portion of the tantalum oxide existing as tantalum (V) oxide to tantalum (IV) oxide. The manganese oxide, if present, may operate as an oxygen scavenger when the manganese oxide exists as manganese (II) oxide. Subjecting the manganese oxide to light may transform at least a portion of the manganese oxide existing as manganese (III) oxide to manganese (II) oxide.

Some example methods of preparing oxygen scavenging packaging materials according to the present disclosure may include disposing a photo-regenerable oxygen scavenger on a surface of a substrate. The oxygen scavenger may include one or more of tantalum oxide and manganese oxide. The tantalum oxide, if present, may operate as an oxygen scavenger when the tantalum oxide exists as tantalum (IV) oxide. Subjecting the tantalum oxide to light may transform at least a portion of the tantalum oxide existing as tantalum (V) oxide to tantalum (IV) oxide, The manganese oxide, if present, may operate as an oxygen scavenger when the manganese oxide exists as manganese (II) oxide. Subjecting the manganese oxide, if present, to light may transform at least a portion of the manganese oxide existing as manganese (III) oxide to manganese (II) oxide.

Some example methods of regenerating an oxygen scavenger according to the present disclosure may include subjecting a photo-regenerable oxygen scavenger to light including wavelengths of about 600 nm to about 660 nm. The oxygen scavenger may include tantalum oxide. The tantalum oxide may operate as an oxygen scavenger when the tantalum oxide exists as tantalum (IV) oxide. Subjecting the tantalum oxide to light may transform at least a portion of the tantalum oxide existing as tantalum (V) oxide to tantalum (IV) oxide. The oxygen scavenger may form at least a portion of a container configured to receive contents such as a beverage, a food, and/or a pharmaceutical.

Some example methods of regenerating an oxygen scavenger according to the present disclosure may include subjecting a photo-regenerable oxygen scavenger to light including wavelengths of about 300 nm to about 400 nm. The oxygen scavenger may include manganese oxide. The manganese oxide may operate as an oxygen scavenger when the manganese oxide exists as manganese (II) oxide. Subjecting the manganese oxide to light may transform at least a portion of the manganese oxide existing as manganese (III) oxide to manganese (II) oxide, The oxygen scavenger may form at least a portion of a container configured to receive contents such as a beverage, a food, and/or a pharmaceutical.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a block diagram of an example container system;

FIG. 2 is a flow chart illustrating an example method of operating an automated preservation management system;

FIG. 3 is a cross-sectional view of an example container;

FIG. 4 is a block diagram of an example container;

FIG. 5 is a plot of x-ray powder diffraction data obtained from an example packaging material before and after photo-regeneration;

FIG. 6 is a plot of Fourier transform infrared spectroscopy data obtained from an example packaging material before and after photo-regeneration;

FIG. 7 is a flow chart illustrating an example method of preparing an oxygen-scavenging packaging material;

FIG. 8 is a flow chart illustrating an example method regenerating an oxygen scavenger;

FIG. 9 is a flow chart illustrating an example method regenerating an oxygen scavenger; and

FIG. 10 is a block diagram illustrating an example computing device; all arranged in accordance with at least some embodiments of the present disclosure.

### DETAILED DESCRIPTION

In the following detailed description, reference is made to the accompanying drawings, which form a part hereof in the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

Methods, systems, devices, and/or apparatus related to oxygen scavenging packaging are described. Some example embodiments according to the present disclosure may pertain to photo-regenerable oxygen scavenging packaging.

Some example embodiments according to the present disclosure may include one or more oxygen scavengers. As used herein, “oxygen scavenger” may refer to materials and/or compounds that may remove oxygen from the interior of a closed package, such as (a) by reacting or combining with entrapped oxygen and/or oxygen perfusing or leaking into the package and/or (b) by catalyzing an oxidation reaction yielding innocuous products. in some example embodiments according to the present disclosure, an oxygen scavenger may include tantalum oxide.

The present disclosure contemplates that tantalum (IV) oxide (TaO₂) may combine with oxygen to form tantalum (V) oxide (Ta₂O₅), such as by the following reaction:

4TaO₂+O₂→2Ta₂O₅

In some example embodiments according to the present disclosure, the combination of tantalum (IV) oxide with oxygen from its surrounding environment to form tantalum (V) oxide may reduce the amount of oxygen in the surrounding environment (e.g., the interior volume of a closed package).

The present disclosure contemplates that air typically contains about 21% oxygen, and reducing the amount of oxygen within a closed package may increase the shelf life of a beverage, a food, and/or a pharmaceutical stored therein, For example, some bacteria that contribute to spoilage of food may use oxygen, and reducing the amount of oxygen within a package containing the food may delay and/or prevent spoilage of the food. For example, when the oxygen concentration of the environment in which produce is stored is maintained less than about 5%, the rate of deterioration of stored produce may be substantially reduced.

The present disclosure contemplates that tantalum (V) oxide may release oxygen to form tantalum (IV) oxide when it is exposed to light. In some example embodiments, subjecting the tantalum (V) oxide to light may excite its electrons, which may cause it to transform to tantalum (IV) oxide. For example, exposure to light (e.g., including wavelengths of about 632 nm) may cause at least a portion of the tantalum (V) oxide to release oxygen and form tantalum (IV) oxide, such as by the following reaction:

Ta₂O₅+hγ (632 nm)→TaO₂+O₂ (g)+Ta*O

Some example embodiments according to the present disclosure may include tantalum oxide arranged to act as a photo-regenerable oxygen scavenger, such as in connection with packaging for a beverage, a food, and/or a pharmaceutical.

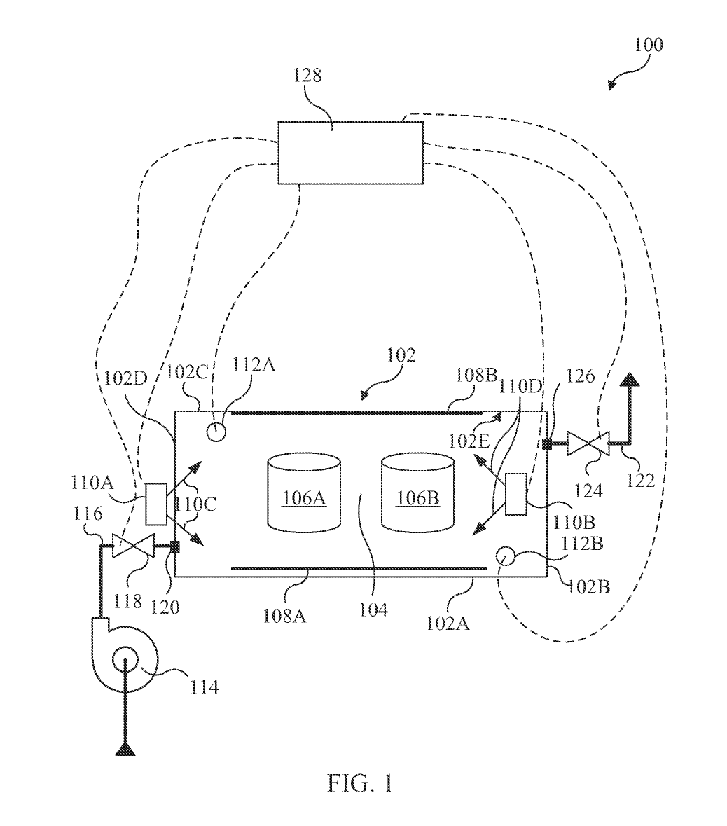

FIG. 1 is a block diagram of an example container system 100, in accordance with at least some embodiments of the present disclosure. Container system 100 may include a container 102 including a structure which may comprise one or more walls 102A, 102B, 102C, 102D which may at least partially define an interior 104 configured to receive one or more contents 106A, 106B (e.g., one or more of a beverage, a food, and a pharmaceutical) therein. For example, the structure including container 102 may include one or more of a bottle, a jar, a drum, a box, a pouch, a bag, a carton, and other packages known in the art. In some example embodiments, interior 104 may be substantially fluidicly isolated from an ambient environment.

Some example containers 102 may include one or more oxygen scavengers 108A, 108B disposed in fluidic communication with the interior volume 104. In some example embodiments, oxygen scavengers 108A, 108B may include tantalum oxide and/or may be disposed within interior 104 of container 102. In some example embodiments one or more oxygen scavengers 108B may be disposed on an interior surface 102B of structure 102A, such as on an interior surface 102E of wall 102C.

Some example containers 102 may include one or more light sources 110A, 110B, which may be arranged to project light 110C, 110D onto at least a portion of one or more of oxygen scavengers 108A, 108B. In some example embodiments, one or more light sources 110A may be disposed outside of interior 104 and/or one or more light sources 110B may be disposed within interior 104. In some example embodiments, light sources 110A, 110B may be configured to emit light comprising wavelengths between about 380 nm and about 750 nm. In some example embodiments, light sources 110A, 110B may be configured to emit light comprising wavelengths of about 600 nm to about 660 nm. In some example embodiments, light sources 110A, 110B may be configured to emit light comprising wavelengths of about 632 nm. in some example embodiments, at least a portion of one or more of oxygen scavengers 108A, 108B may be subjected to sunlight, which may include light comprising wavelengths of about 632 nm. it is within the scope of the disclosure to use a separately provided light source instead of or in addition to light sources 110A, 110B.

Some example containers 102 may include one or more sensors configured to detect one or more conditions associated with interior 104 of container 102. For example, some example containers 102 may comprise one or more oxygen sensors 112A, 112B configured to detect oxygen within interior volume 104.

Some example containers 102 may include a purge system, which may include an air mover such as a blower 114. Blower 114 may be arranged to deliver air (or other gas) to interior 104 of container 102, such as via purge line 116, Purge line 116 may include one or more isolation valves 118, which may be arranged to isolate interior 104 of container. In some example embodiments, purge tine 116 may be coupled to container 102 at a port 120. Air (or other gas) delivered to interior 104 of container 102 by blower 114 may be vented from interior 104 via a vent line 122, which may include one or more isolation valves 124 and/or which may be coupled to container 102 at a port 126. It will be understood by those of skill in the art that reversing the direction of flow through blower 114 will cause air (or other gas) to be drawn into interior 104 via vent line 122 and out of interior via line 116 and blower 114. In some such embodiments, line 116 may be referred to as a vacuum line. In some example embodiments, a purge gas comprising less oxygen than ambient air may be used by the purge system. For example, nitrogen may be used as a purge gas.

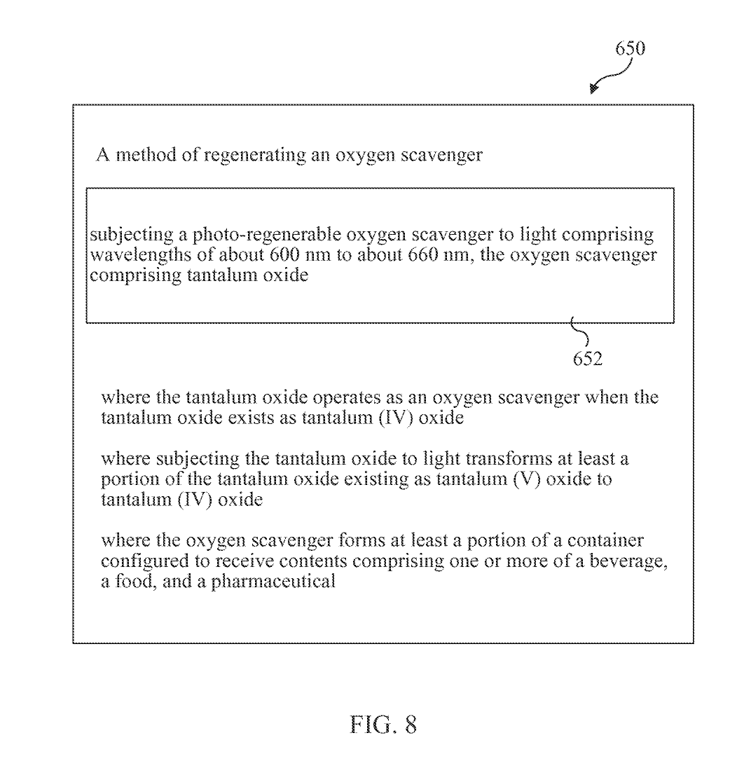

Some example container systems 100 may include an automated preservation management system (APMS) 128, which may be operatively coupled to one or more of light sources 110A, 110B, oxygen sensors 112A, 112B, air mover 114, and/or isolation valves 118, 124. These components are available to those of skill in the art. For example, APMS 128 may comprise one or more microprocessors configured to receive data from and/or to control one or more of light sources 110A, 110B, oxygen sensors 112A, 112B, air mover 114, and/or isolation valves 118, 124. In some example embodiments, APMS 128 may comprise a computing device, such as those described below in connection with FIG. 8.

In some example embodiments, APMS 128 may be configured to periodically and/or intermittently monitor conditions, such as oxygen concentration, within interior 104 (e.g., using oxygen sensors 112A, 112B). APMS 128 may be configured to automatically operate isolation valves 118, 124, blower 114, and/or light sources 110A, 110B. For example, APMS 128 may automatically apply appropriate electrical energy to open isolation valves 118, 124, which may comprise solenoid-operated valves. APMS 128 may be configured to automatically control operation of blower 114 to flow air (or other gas) through interior 104. APMS 128 may be configured to automatically control light sources 110A, 110B, which may project light 110C, 110D onto oxygen scavengers 108A, 108B.

Oxygen within interior 104 may be captured by oxygen scavengers 108A, 108B, which may include tantalum (IV) oxide, thereby forming tantalum (V) oxide. APMS 128 may monitor oxygen concentration within interior 104, such as by using oxygen sensors 112A, 112B. Upon detection of an oxygen concentration at or above a predetermined set point, upon elapse of a predetermined time period, and/or when manually initiated, APMS 128 may direct opening of isolation valves 118, 124. APMS may energize blower 114 to flow air (or other gas) through interior 104 via purge line 116 and/or vent line 122. APMS may energize light sources 110A, 110B to project light 110C, 110D onto oxygen scavengers 108A, 108B, Light 110C, 110D may cause at least a portion of the tantalum (V) oxide of oxygen scavengers 108A, 108B to release oxygen and form tantalum (IV) oxide. At least a portion of the released oxygen may be removed from interior 104 by the flowing air (or other gas). Upon detection of a predetermined oxygen concentration in interior 104, upon elapse of a predetermined time period, and/or upon manual operation, APMS may de-energize light sources 110A, 110B, de-energize blower 114, and/or direct shutting of isolation valves 118, 124.

In some example embodiments, contents 106A, 106B may be placed into interior 104 of container 102, and container 102 may be substantially sealed from the ambient environment prior to operation of APMS 128. In some example embodiments, contents 106A, 106B may be placed into interior 104 of container 102 after oxygen scavengers 108A, 108B have been subjected to light 110C, 110D. In some example embodiments, previously held contents 106A, 106B of container 102 may be removed from interior 104 prior to subjecting oxygen scavengers 108A, 108B to light 110C, 110D. In some example embodiments, oxygen scavengers 108A, 108B may be subjected to a vacuum during at least a portion of the time while being subjected to light 110C, 110D.

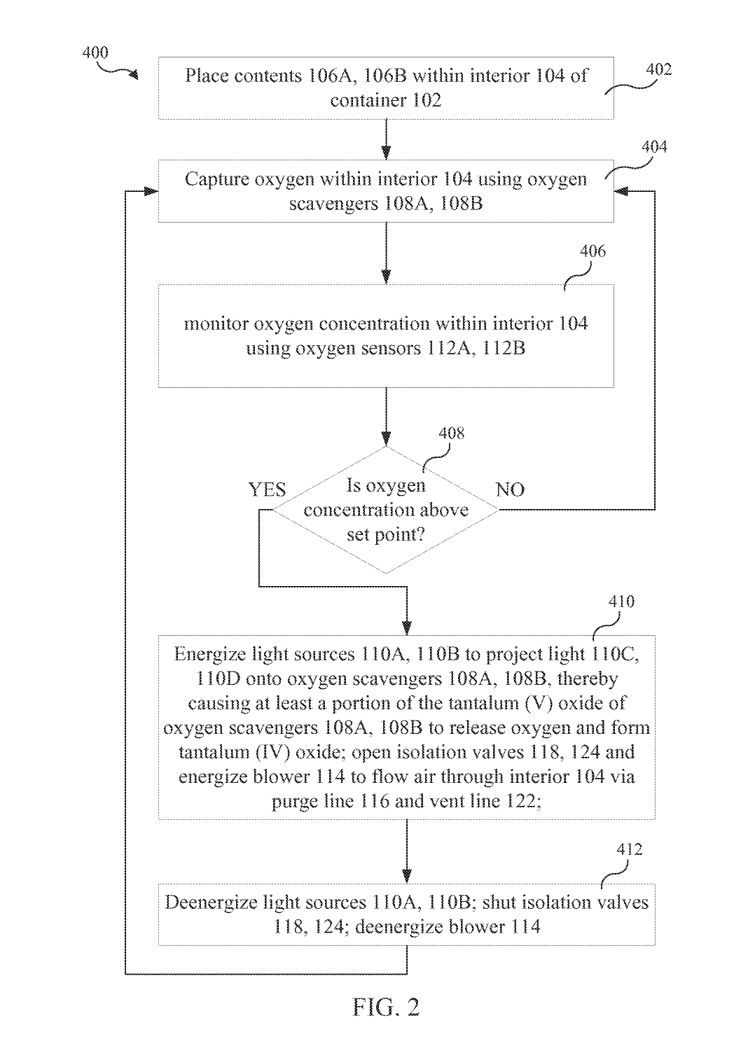

FIG. 2 is a flow chart illustrating an example method of operating an automated preservation management system 128 according to at least some embodiments of the present disclosure. Method 400 may include an operation 402, which may include placing contents 106A, 106B within interior 104 of container 102. Operation 402 may be followed by an operation 404, which may include capturing oxygen within interior 104 using oxygen scavengers 108A, 108B. An operation 406 may occur during and/or after operation 404, and may include monitoring an oxygen concentration within interior 104 using oxygen sensors 112A, 112B. Using the oxygen concentrations measured in operation 406, an operation 408 may include determining whether the oxygen concentration above a set point. If the oxygen concentration is not above a set point, the method may return to operation 404. If the oxygen concentration is above a set point, the method may proceed to an operation 410, which may include energizing light sources 110A, 110B to project light 110C, 110D onto oxygen scavengers 108A, 108B, thereby causing at least a portion of the tantalum (V) oxide of oxygen scavengers 108A, 108B to release oxygen and form tantalum (IV) oxide and/or opening isolation valves 118, 124 and energizing blower 114 to flow air through interior 104 via purge line 116 and vent line 122. Following operation 410 may be an operation 412, which may include deenergizing light sources 110A, 110B, shutting isolation valves 118, 124, and/or deenergizing blower 114. The method may then return to operation 404.

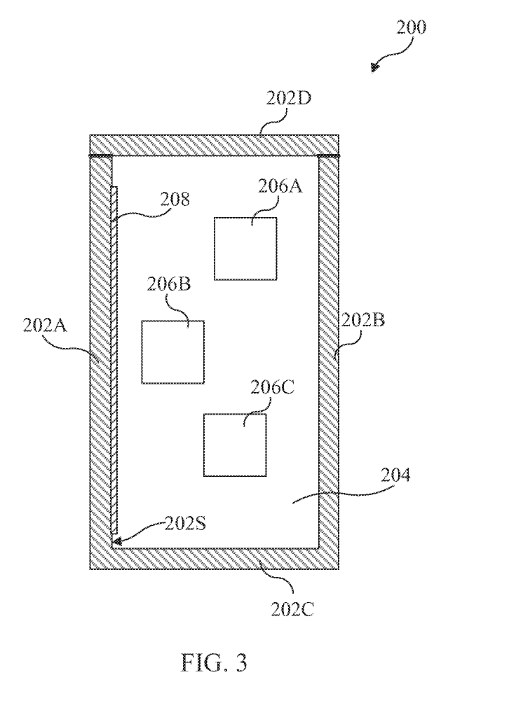

FIG. 3 is a cross-sectional view of an example container 200, in accordance with at least some embodiments of the present disclosure. Container 200 may include a structure which may comprise one or more walls 202A, 202B, 202C, 202D, which may at least partially define an interior 204 configured to receive one or more contents 206A, 206B, 206C (e.g., one or more of a beverage, a food, and a pharmaceutical) therein. For example, the structure comprising container 200 may include one or more of a bottle, a jar, a drum, a box, a pouch, a bag, a carton, and other packages known in the art. In some example embodiments, interior 204 may be substantially fluidicly isolated from an ambient environment.

In some example embodiments, one or more of walls 202A, 202B, 202C, 202D may be constructed from various materials known in the art, such as metals (e.g., aluminum and steel), polymers (e.g., polyethylene and polycarbonate), paperboard, cardboard, and the like. One or more of walls 202A, 202B, 202C, 202D may comprise a substrate with which a photo-regenerable oxygen scavenger 208 (e.g., tantalum oxide) is operatively associated. In some example embodiments, one or more of walls 202A, 202B, 202C, 202D may include a closure configured to selectively substantially seal interior 204 from the ambient environment. In some example embodiments, oxygen scavenger 208 may be disposed on a surface 202S of one or more walls 202A, 202B, 202C, and 202D comprising a substrate.

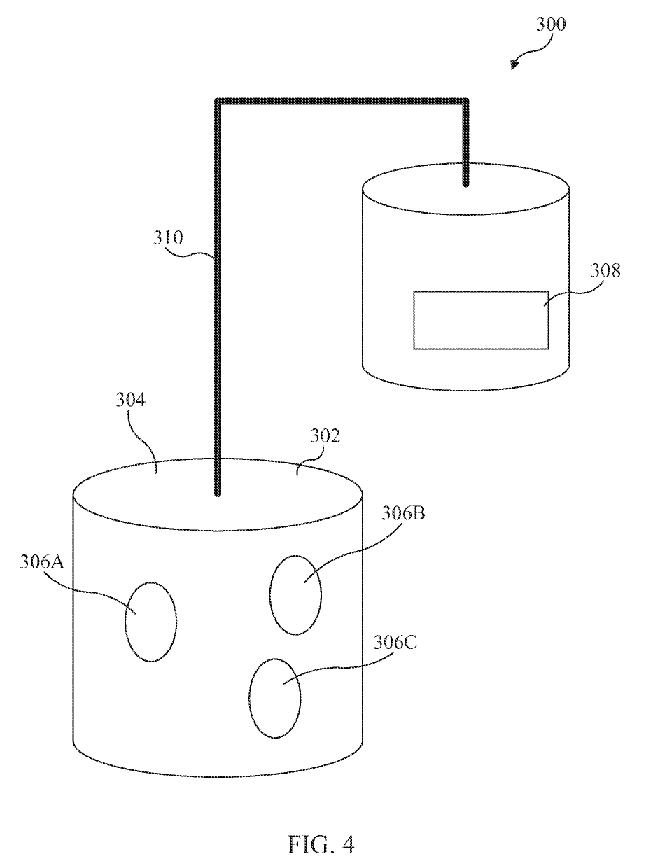

In some example embodiments, a photo-regenerable oxygen scavenger may be disposed in fluidic communication with an interior of a container. For example, FIG. 4 is a block diagram of an example container system 300, in accordance with at least some embodiments of the present disclosure. Container system 300 may include a container 302 which may be configured to receive one or more contents 306A, 306B, 306C within an interior 304 thereof. Interior 304 may be in fluidic communication with a photo-regenerable oxygen scavenger 308, such as tantalum oxide. In some example embodiments, interior 304 may be fluidicly coupled with oxygen scavenger 308 via a conduit 310.

Oxygen scavenging packaging materials in accordance with at least some aspects of the present disclosure may be constructed by disposing tantalum oxide on a surface of the packaging material. The surface of the packaging material may be prepared to receive the tantalum oxide, such as by electrochemically cleaning the surface using a solvent and/or by using sonication to remove unwanted impurities from the surface. Tantalum oxide may be disposed on the surface of the packaging material by one or more of electrodeposition (e.g., using dimethyl sulfoxide and/or by being dispersed in water using sonication), dip coating (e.g., heated to about 100 degrees C.), spin coating (e.g., with heating), spray coating (e.g., with heating), vacuum thermal evaporation deposition, sputtering, and reactive sputtering. In some at least some tantalum oxide may be disposed on the packaging material prior to its assembly into a container. In some example embodiments, at least some tantalum oxide may be disposed on the packaging material after its assembly into the container.

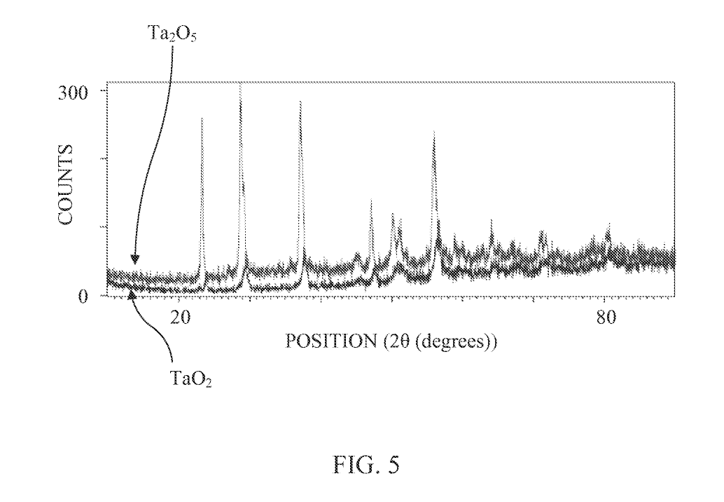

FIG. 5 is a plot of x-ray powder diffraction (XRD) data obtained from an example packaging material before and after photo-regeneration, in accordance with at least some embodiments of the present disclosure. An oxygen scavenging surface comprising tantalum oxide was exposed to oxygen (forming tantalum (V) oxide), and the data labeled “Ta₂O₅” in FIG. 5 was obtained. The observed diffraction peaks are in good agreement with the Joint Committee on Powder Diffraction Standards (JCPDS) No. 18-1304 data for tantalum oxide. These diffraction peaks may be associated with (003), (200) and (203) planes related to the hexagonal δ-Ta₂O₅ phase. Next, the oxygen scavenging surface was exposed light from a green light emitting diode, and the data labeled “TaO₂” in FIG. 5 was obtained. This data indicates that at least some of the tantalum oxide lost its crystalline nature. The peaks have reduced intensities and are shifted by about 1 radian.

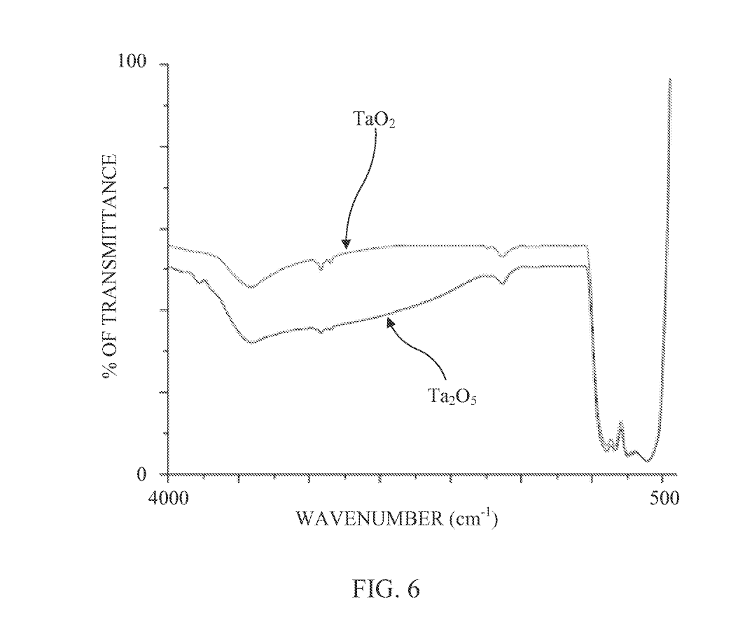

FIG. 6 is a plot of Fourier transform infrared spectroscopy (FTIR) data obtained from an example packaging material before and after photo-regeneration, in accordance with at least some embodiments of the present disclosure. An oxygen scavenging surface including tantalum oxide was exposed to oxygen (forming tantalum (V) oxide), and the data labeled “Ta₂O₅” in FIG. 6 was obtained. Then, the oxygen scavenging surface was exposed light from a green light emitting diode light source. Then, the data labeled “TaO₂” in FIG. 5 was obtained. The absorption bands at about 682 cm-1 and 731 cm-1 may be attributed to the O=3Ta stretching mode of Ta₂O_{5 and TaO}₂ in the polycrystalline phase. The presence of a band at about 872 cm-1 may be related the Ta—O—Ta stretching mode. The presence of a band at about 3422 cm-1 may be related to the absorbed —OH stretching mode for the absorption oxygen.

In some example embodiments according to at least some aspects of the present disclosure, regeneration of tantalum (V) oxide to tantalum (VI) oxide by exposure to light may be substantially complete. In other words, substantially all of the tantalum (V) oxide may be converted to tantalum (VI) oxide. In some example embodiments according to at least some aspects of the present disclosure, less than all of the tantalum (V) oxide may be converted to tantalum (VI) oxide by exposure to light. In some such embodiments, the amount of tantalum (VI) oxide available for oxygen scavenging after regeneration may decrease with each use and regeneration of the oxygen scavenger. Some example embodiments may be configured to include an amount of tantalum oxide such that a desired oxygen scavenging capacity is available after multiple uses and regenerations of the oxygen scavenger.

In some example embodiments according to at least some aspects of the present disclosure, manganese oxide may be used as an oxygen scavenger instead of and/or in addition to tantalum oxide. For example, manganese (II) oxide (MnO) may capture oxygen from its surrounding environment, becoming manganese (III) oxide (Mn₂O₃). At least some of the manganese (III) oxide may be regenerated into manganese (II) oxide by exposure to light (e.g., ultraviolet light at about 352 nm). In some example embodiments, light sources may be configured to emit light comprising wavelengths between about 200 nm and about 500 nm. In some example embodiments, light sources may be configured to emit light comprising wavelengths of about 300 nm to about 400 nm. In some example embodiments, light sources may be configured to emit light comprising wavelengths of about 352 nm. In some example embodiments according to at least some aspects of the present disclosure, manganese oxide may operate as a photo-regenerable oxygen scavenger according to the following equation:

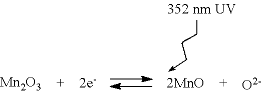

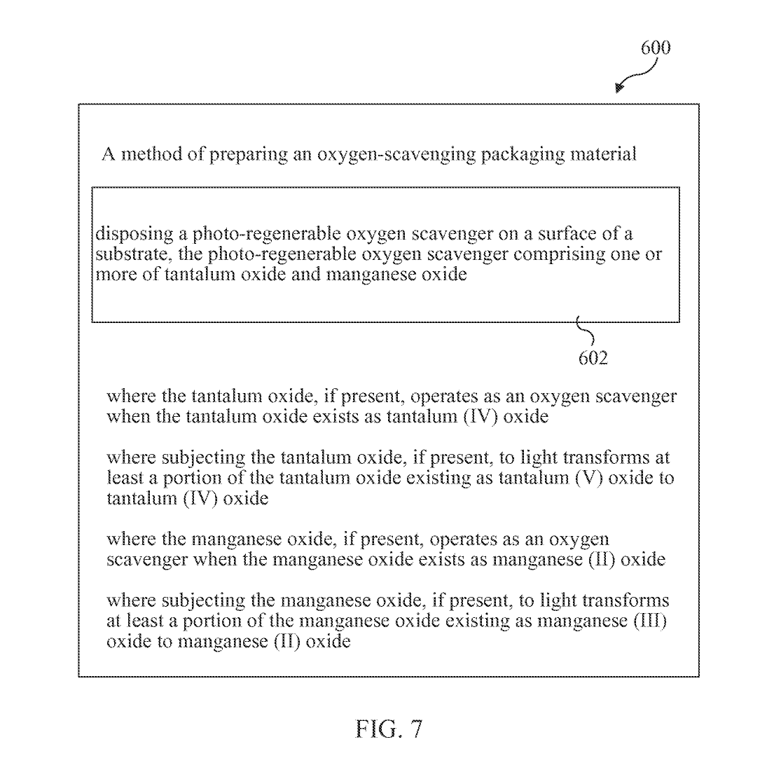

FIG. 7 is a flow chart illustrating an example method 600 of preparing an oxygen-scavenging packaging material, in accordance with at least some embodiments of the present disclosure. Method 600 may include an operation 602, which may include disposing a photo-regenerable oxygen scavenger on a surface of a substrate. The photo-regenerable oxygen scavenger may comprise one or more of tantalum oxide and manganese oxide. The tantalum oxide, if present, may operate as an oxygen scavenger when the tantalum oxide exists as tantalum (IV) oxide. Subjecting the tantalum oxide, if present, to light may transform at least a portion of the tantalum oxide existing as tantalum (V) oxide to tantalum (IV) oxide. The manganese oxide, if present, may operate as an oxygen scavenger when the manganese oxide exists as manganese (II) oxide. Subjecting the manganese oxide, if present, to light may transform at least a portion of the manganese oxide existing as manganese (III) oxide to manganese (II) oxide.

FIG. 8 is a flow chart illustrating an example method 650 of regenerating an oxygen scavenger, in accordance with at least some embodiments of the present disclosure. Method 650 may include operation 652, which may include subjecting a photo-regenerable oxygen scavenger to light comprising wavelengths of about 600 nm to about 660 nm. The oxygen scavenger may include tantalum oxide. The tantalum oxide may operate as an oxygen scavenger when the tantalum oxide exists as tantalum (IV) oxide. Subjecting the tantalum oxide to light may transform at least a portion of the tantalum oxide existing as tantalum (V) oxide to tantalum (IV) oxide. The oxygen scavenger may form at least a portion of a container configured to receive contents, which may include one or more of a beverage, a food, and a pharmaceutical.

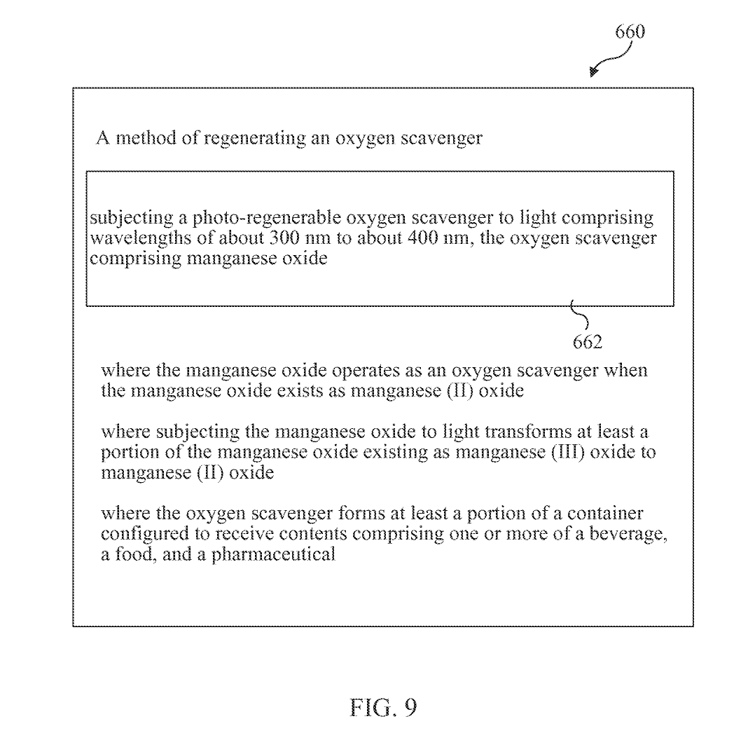

FIG. 9 is a flow chart illustrating an example method 660 of regenerating an oxygen scavenger, in accordance with at least some embodiments of the present disclosure. Method 660 may include operation 662, which may include subjecting a photo-regenerable oxygen scavenger to light comprising wavelengths of about 300 nm to about 400 nm. The oxygen scavenger may comprise manganese oxide. The manganese oxide may operate as an oxygen scavenger when the manganese oxide exists as manganese (II) oxide. Subjecting the manganese oxide to light may transform at least a portion of the manganese oxide existing as manganese (III) oxide to manganese (II) oxide. The oxygen scavenger may form at least a portion of a container configured to receive contents comprising one or more of a beverage, a food, and a pharmaceutical.

Some example packaging materials and/or containers may firm a part of and/or may be placed within temperature controlled containers, such as refrigerators and/or freezers. Some example packaging materials and/or containers may form a part of and/or may be placed within storage containers, warehouses, storage units, etc.

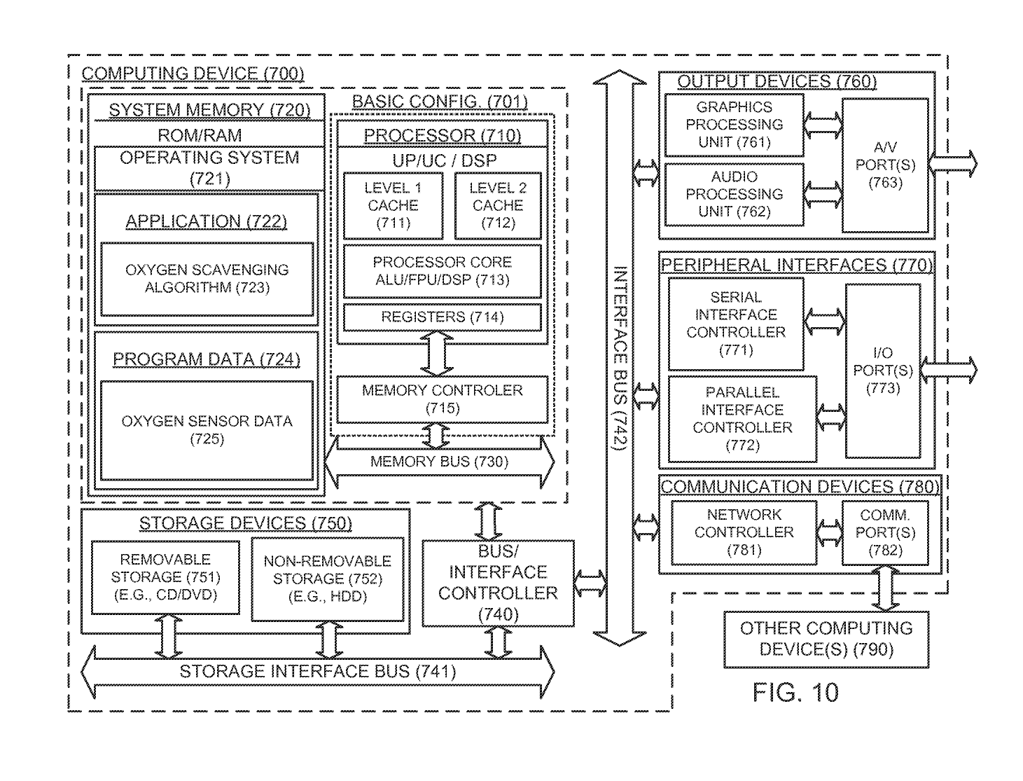

FIG. 10 is a block diagram illustrating an example computing device 700 that may include APMS 128 in accordance with at least some embodiments of the present disclosure. In a very basic configuration 701, computing device 700 typically may include one or more processors 710 and system memory 720. A memory bus 730 may be used for communicating between the processor 710 and the system memory 720.

Depending on the desired configuration, processor 710 may be of any type including but not limited to a microprocessor (μP), a microcontroller (μC), a digital signal processor (DSP), or any combination thereof. Processor 710 may include one more levels of caching, such as a level one cache 711 and a level two cache 712, a processor core 713, and registers 714. An example processor core 713 may include an arithmetic logic unit (ALU), a floating point unit (FPU), a digital signal processing core (DSP Core), or any combination thereof. An example memory controller 715 may also be used with the processor 710, or in some implementations the memory controller 715 may be an internal part of the processor 710.

Depending on the desired configuration, the system memory 720 may be of any type including but not limited to volatile memory (such as RAM), non-volatile memory (such as ROM, flash memory, etc.) or any combination thereof. System memory 720 may include an operating system 721, one or more applications 722, and program data 724. Application 722 may include an oxygen scavenging algorithm 723 that may be arranged to direct operation of other components upon detection of a predetermined oxygen concentration as described herein. Program Data 724 may include oxygen sensor data 725 that may be useful for controlling other components as described herein. In some embodiments, application 722 may be arranged to operate with program data 724 on an operating system 721 such that example implementations of oxygen scavenging container systems may be provided as described herein. This described basic configuration is illustrated in FIG. 7 by those components within dashed line 701.

Computing device 700 may have additional features or functionality, and additional interfaces to facilitate communications between the basic configuration 701 and any required devices and interfaces. For example, a bus/interface controller 740 may be used to facilitate communications between the basic configuration 701 and one or more data storage devices 750 via a storage interface bus 741. The data storage devices 750 may be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 720, removable storage 751 and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of device 700.

Computing device 700 may also include an interface bus 742 for facilitating communication from various interface devices (e.g., output interfaces, peripheral interfaces, and communication interfaces) to the basic configuration 701 via the bus/interface controller 740. Example output devices 760 include a graphics processing unit 761 and an audio processing unit 762, which may be configured to communicate to various external devices such as a display or speakers via one or more A/V ports 763. Other example output devices include valve controllers and light source controllers. Example peripheral interfaces 770 include a serial interface controller 771 or a parallel interface controller 772, which may be configured to communicate with external devices such as input devices (e.g., keyboard, mouse, pen, voice input device, touch input device, sensors etc.) or other peripheral devices (e.g., printer, scanner, etc.) via one or more I/O ports 773. An example communication device 780 includes a network controller 781, which may be arranged to facilitate communications with one or more other computing devices 790 over a network communication link via one or more communication ports 782.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

### EXAMPLES

### Example 1

### Food Preservation Using Container With Tantalum Oxide

Testing involving an example embodiment according to the present disclosure was conducted. Surfaces of metal plates were prepared by removing unwanted impurities using sonication. Tantalum (IV) oxide was electrodeposited on the surfaces using dimethyl sulfoxide and an applied voltage differential of 2 VDC. A platinum positive electrode was used and the metal plates acted as the negative electrode. After ten minutes, the plates were removed from the electrodeposition apparatus and were assembled into a box with the tantalum oxide coated surfaces facing the interior of the box. Noodles were placed into the box and the box was sealed. Once a day, the box was vented and light emitted by green light emitting diodes was directed at the tantalum oxide coated surfaces. Noodles stored in the box at about 27-30 degrees C. remained unspoiled and edible after one week, while noodles stored under similar conditions in a closed container without a tantalum oxide oxygen scavenger spoiled and became inedible in approximately one day.

### Example 2

### Regeneration of Tantalum Oxide Oxygen Scavenger Using Sunlight

In some example embodiments according to at least some aspects of the present disclosure, a container (e.g., container 102 described above) may be constructed with tantalum (IV) oxide on interior surfaces thereof. The tantalum (IV) oxide may capture oxygen from the interior of the container, becoming tantalum (V) oxide. At least some of the tantalum (V) oxide may be regenerated into tantalum (IV) oxide by exposure to bright sunlight, which may include at least some light at about 632 nm.

### Example 3

### Container Including Manganese Oxide Oxygen Scavenger

In some example embodiments according to at least some aspects of the present disclosure, a container (e.g., container 102 described above) may be constructed with manganese (II) oxide on interior surfaces thereof. The manganese (II) oxide may capture oxygen from the interior of the container, becoming manganese (III) oxide. At least some of the manganese (III) oxide may be regenerated into manganese (II) oxide by exposure to light, such as ultraviolet light at about 352 nm.

### Example 4

### Pharmaceutical Storage Using Container With Tantalum Oxide

Some example embodiments according to the present disclosure may be configured for storage of pharmaceuticals. For example, a pharmaceutical subject to oxidative degradation (e.g., sodium picosulfate (4,4′-(2-pyridylmethylene)diphenyl bis(hydrogen sulfate) disodium)) may be stored in a container, such as container 200 of FIG. 3. Oxygen scavenger 208, which may comprise tantalum oxide, may capture oxygen from interior 204, which may reduce the concentration of oxygen in interior 204. Reducing the oxygen concentration in interior 204 may reduce the rate of oxidative degeneration of the pharmaceutical stored therein.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc,). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A packaging material comprising:
a substrate; and
a photo-regenerable oxygen scavenger comprising one or more of tantalum oxide and manganese oxide, the photo-regenerable oxygen scavenger being operatively associated with the substrate;
wherein the tantalum oxide, if present, operates as an oxygen scavenger when the tantalum oxide exists as tantalum (IV) oxide;
wherein subjecting the tantalum oxide, if present, to light transforms at least a portion of the tantalum oxide existing as tantalum (V) oxide to tantalum (IV) oxide;
wherein the manganese oxide, if present, operates as an oxygen scavenger when the manganese oxide exists as manganese (II) oxide; and
wherein subjecting the manganese oxide, if present, to light transforms at least a portion of the manganese oxide existing as manganese (III) oxide to manganese (II) oxide.

2. (canceled)

3. (canceled)

4. The packaging material of claim 1, wherein the photo-regenerable oxygen scavenger is disposed on a surface of the substrate.

5. The packaging material of claim 1, wherein the substrate comprises one or more of a metal and a polymer.

6. The packaging material of claim 1, wherein the substrate comprises polycarbonate.

7. A container comprising:
a structure at least partially defining an interior volume for receiving contents therein, the interior volume being configured to be substantially fluidicly isolated from an ambient environment; and
a photo-regenerable oxygen scavenger disposed in fluidic communication with the interior volume, the oxygen scavenger comprising one or more of tantalum oxide and manganese oxide;
wherein the tantalum oxide, if present, operates as an oxygen scavenger when the tantalum oxide exists as tantalum (IV) oxide;
wherein subjecting the tantalum oxide, if present, to light transforms at least a portion of the tantalum oxide existing as tantalum (V) oxide to tantalum (IV) oxide;
wherein the manganese oxide, if present, operates as an oxygen scavenger when the manganese oxide exists as manganese (II) oxide; and
wherein subjecting the manganese oxide, if present, to light transforms at least a portion of the manganese oxide existing as manganese (III) oxide to manganese (II) oxide.

8. The container of claim 7, wherein the interior volume is configured to receive contents comprising one or more of a beverage, a food, and a pharmaceutical therein.

9. The container of claim 7, further comprising a light source arranged to project light onto at least a portion of the photo-regenerable oxygen scavenger.

10. The container of claim 9, wherein the light source is configured to emit light comprising wavelengths between about 380 nm and about 750 nm.

11. The container of claim 9, wherein the light source is configured to emit light comprising wavelengths of about 632 nm.

12. The container of claim 9, wherein the light source is configured to emit light comprising wavelengths between about 200 nm and about 500 nm.

13. The container of claim 9, wherein the light source is configured to emit light comprising wavelengths of about 352 nm.

14. The container of claim 7, further comprising an oxygen sensor configured to detect the oxygen within the interior volume.

15. The container of claim 14, further comprising a light source and a purge system configured for automatic operation upon detection, by the oxygen sensor, of a predetermined oxygen concentration in the interior volume.

16. The container of claim 7,
wherein the structure comprises one or more walls interposing the interior volume and the ambient environment; and
wherein the photo-regenerable oxygen scavenger is disposed on an interior surface of one or more of the walls.

17. The container of claim 7, wherein the structure comprises one or more of a bottle, a jar, a drum, a box, a pouch, a bag, and a carton.

18. The container of claim 17, wherein the photo-regenerable oxygen scavenger is disposed on an interior surface of the structure.

19. The container of claim 7, further comprising a port configured to engage one or more of a vacuum line and a purge line.

20. A method of preparing an oxygen-scavenging packaging material, the method comprising:
disposing a photo-regenerable oxygen scavenger on a surface of a substrate, the photo-regenerable oxygen scavenger comprising one or more of tantalum oxide and manganese oxide;
wherein the tantalum oxide, if present, operates as an oxygen scavenger when the tantalum oxide exists as tantalum (IV) oxide;
wherein subjecting the tantalum oxide, if present, to light transforms at least a portion of the tantalum oxide existing as tantalum (V) oxide to tantalum (IV) oxide;
wherein the manganese oxide, if present, operates as an oxygen scavenger when the manganese oxide exists as manganese (II) oxide; and
wherein subjecting the manganese oxide, if present, to light transforms at least a portion of the manganese oxide existing as manganese (III) oxide to manganese (II) oxide.

21. The method of claim 20, wherein disposing comprises one or more of electrodeposition, dip coating, spin coating, spray coating, vacuum thermal evaporation deposition, sputtering, and reactive sputtering.

22. The method of claim 20, further comprising, prior to disposing the photo-regenerable oxygen scavenger on the surface of a substrate, preparing the surface of the substrate by removing at least some impurities from the surface.

23. The method of claim 22, wherein preparing the surface comprises cleaning the surface using one or more of a solvent and ultrasound.

24. The method of claim 20, further comprising constructing a container comprising the substrate.

25. A method of regenerating an oxygen scavenger, the method comprising:
subjecting a photo-regenerable oxygen scavenger to light comprising wavelengths of about 600 nm to about 660 nm, the oxygen scavenger comprising tantalum oxide;
wherein the tantalum oxide operates as an oxygen scavenger when the tantalum oxide exists as tantalum (IV) oxide;
wherein subjecting the tantalum oxide to light transforms at least a portion of the tantalum oxide existing as tantalum (V) oxide to tantalum (IV) oxide; and
wherein the oxygen scavenger forms at least a portion of a container configured to receive contents comprising one or more of a beverage, a food, and a pharmaceutical.

26. The method of claim 25, further comprising, after subjecting the photo-regenerable oxygen scavenger to light, placing the contents into the container.

27. The method of claim 25, further comprising, prior to subjecting the photo-regenerable oxygen scavenger to light, at least partially removing previously held contents of the container.

28. The method of claim 25, wherein subjecting the photo-regenerable oxygen scavenger to light comprises exposing the photo-regenerable oxygen scavenger to sunlight.

29. The method of claim 25, wherein subjecting the photo-regenerable oxygen scavenger to light comprises operating a light source to direct light onto the photo-regenerable oxygen scavenger.

30. The method of claim 25, further comprising purging an atmosphere adjacent the photo-regenerable oxygen scavenger during at least a portion of subjecting the photo-regenerable oxygen scavenger to light using one or more of ambient air and a purge gas comprising less oxygen than the ambient air.

31. The method of claim 25, further comprising exposing the photo-regenerable oxygen scavenger to a vacuum during at least a portion of subjecting the photo-regenerable oxygen scavenger to light.

32. The method of claim 25, wherein subjecting the photo-regenerable oxygen scavenger to light is one or more of manually and automatically initiated based at least in part upon a detected oxygen concentration in a substantially enclosed environment containing the photo-regenerable oxygen scavenger.

33. The method of claim 25, wherein the light comprises wavelengths of about 632 nm.

34. A method of regenerating an oxygen scavenger, the method comprising:
subjecting a photo-regenerable oxygen scavenger to light comprising wavelengths of about 300 nm to about 400 nm, the oxygen scavenger comprising manganese oxide;
wherein the manganese oxide operates as an oxygen scavenger when the manganese oxide exists as manganese (II) oxide;
wherein subjecting the manganese oxide to light transforms at least a portion of the manganese oxide existing as manganese (III) oxide to manganese (II) oxide; and
wherein the oxygen scavenger forms at least a portion of a container configured to receive contents comprising one or more of a beverage, a food, and a pharmaceutical.

35. The method of claim 34, wherein subjecting the photo-regenerable oxygen scavenger to light comprises exposing the photo-regenerable oxygen scavenger to sunlight.

36. The method of claim 34, wherein subjecting the photo-regenerable oxygen scavenger to light comprises operating a light source to direct light onto the photo-regenerable oxygen scavenger.

37. The method of claim 34, further comprising purging an atmosphere adjacent the photo-regenerable oxygen scavenger during at least a portion of subjecting the photo-regenerable oxygen scavenger to light using one or more of ambient air and a purge gas comprising less oxygen than the ambient air.

38. The method of claim 25, wherein the light comprises wavelengths of about 352 nm.
